(19) United States
(12) Patent Application Publication
(10) Pub. No.: US 2015/0358575 A1
(43) Pub. Date: Dec. 10, 2015

(54) WIRELESS CAMERA, WIRELESS NETWORK VIDEO RECORDER (NVR), AND METHOD FOR REGISTERING WIRELESS CAMERA WITH WIRELESS NVR

(71) Applicant: ITX SECURITY CO., LTD., Seoul (KR)

(72) Inventor: Dong Uk PARK, Gwangmyeong-si (KR)

(73) Assignee: ITX SECURITY CO., LTD., Seoul (KR)

(21) Appl. No.: 14/734,108

(22) Filed: Jun. 9, 2015

(30) Foreign Application Priority Data
Jun. 9, 2014 (KR) 10-2014-0069699

(51) Int. Cl. H04N 5/77; G11B 31/00; G06F 21/44; H04N 5/232

(52) U.S. Cl. CPC H04N 5/77; H04N 5/23206; G11B 31/006; G06F 21/445

(57) ABSTRACT

A wireless camera capable of being automatically registered with a wireless Network Video Recorder (NVR), the wireless NVR capable of automatically registering the wireless camera, and a method for registering the wireless camera with the wireless NVR. Before establishing connection between the wireless NVR and the wireless camera, the present disclosure enables automatic access therebetween using a plug-and-play technique so as to improve convenience of a user.

### CROSS-REFERENCE TO RELATED APPLICATION(S)

This application claims priority from Korean Patent Application No. 10-2014-0069699, filed on Jun. 9, 2014, in the Korean Intellectual Property Office, the entire disclosure of which is incorporated herein by reference for all purposes.

### BACKGROUND

1. Field

The following description relates to a technology of registering a wireless camera with a wireless Network Video Recorder (NVR) and, more particularly, to a wireless camera capable of being automatically registered with a wireless NVR, the wireless NVR capable of automatically registering the wireless camera, and a method for automatically registering the wireless camera with the wireless NVR.

2. Description of the Related Art

In order to set up a network between a Network Video Recorder (NVR) and an Internet Protocol (IP) camera, knowledge related to IP network configuration are required. Therefore, it is a challenge for an unskilled person to manually set up a network between the NVR and the IP camera.

To solve this drawback, Korean Patent Publication No. 10-2013-0119248 (Oct. 31, 2013) proposed a technology for setting up the automatic connection of an IP camera on a NVR with minimizing intervention of a user so as to resolve inconvenience that users who are not knowledgeable about IP network configuration manually have to set up network configuration for the NVR and the IP camera.

The inventor of this present disclosure has studied a technology for automatically access between a wireless NVR and a wireless camera using a plug-and-play technique in an access procedure before establishing connection between the wireless NVR and the wireless camera, thereby improving user convenience.

### SUMMARY

The following description aims to provide a wireless camera capable of being automatically registered with a wireless Network Video Recorder (NVR), the wireless NVR capable of automatically registering the wireless camera, and a method for registering the wireless camera with the wireless NVR, wherein access between the wireless NVR and the wireless camera are automatically made before connection therebetween is established.

In one general aspect, there is provided a wireless camera capable of being automatically registered with a wireless Network Video Recorder (NVR), including: a storage configured to store a list of Service Set Identifiers (SSIDs) of wireless NVRs acting as Access Points (APs) and initial access passwords for the respective SSIDs; a provisional access component configured to, once the wireless camera is turned on, make an attempt for provisional access to the wireless NVRs in sequence by reference to the list of SSIDs for the wireless NVRs and the initial access passwords for the respective SSIDs; and an actual access component configured to request authentication in accordance with a predefined protocol from a particular wireless NVR with which the provisional access has been established, and, in response to confirmation of the authentication from the particular wireless NVR, establish actual access to the particular wireless NVR.

In another general aspect, there is provided a wireless Network Video Recorder (NVR) capable of automatically registering a wireless camera, including: a storage configured to store a Service Set Identifier (SSID) of the wireless NVR and an initial access password for the SSID; a provisional access processor configured to determine if an SSID and an initial access password included in a provisional access request from a particular wireless camera acting as a station match the SSID and the initial access password stored in the storage of the wireless NVR, and, if so, allow provisional access to the particular wireless camera; and an actual access processor configured to, in response to an authentication request from the particular wireless camera with which the provisional access has been established, verify authentication of the particular wireless camera in accordance with a predefined protocol, and, in response to confirmation of the authentication, allow actual access to the particular wireless camera.

In yet another general aspect, there is provided a method for automatically registering a wireless camera to a wireless Network Video Recorder, including: once the wireless camera is turned on, making, at the wireless camera, an attempt for provisional access to wireless Network Video Recorders (NVRs) by reference to a pre-stored list of Service Set Identifiers (SSIDs) of the respective wireless NVRs and initial access passwords for the respective SSIDs; allowing, at a particular wireless NVR, provisional access to a particular wireless camera in a case where an SSID and an initial access password included in a provisional access request from the particular wireless camera match an SSID and an initial access password pre-stored in the particular wireless NVR; requesting, at the particular wireless camera with which the provisional access has been established, authentication in accordance with a predefined protocol from the particular wireless NVR; verifying, at the particular wireless NVR, authentication of the particular wireless camera in accordance with the predefined protocol; and in response to confirmation of the authentication of the particular wireless camera, allowing, at the particular wireless NVR, actual access to the particular wireless camera.

According to yet another general aspect, the predefined protocol includes changing an initial access password into a new access password.

Other features and aspects may be apparent from the following detailed description, the drawings, and the claims.

### BRIEF DESCRIPTION OF THE DRAWINGS

FIG. 1 is a diagram illustrating a wireless Network Video Recorder (NVR) network system.

FIG. 2 is a block diagram illustrating a configuration of a wireless camera capable of being automatically registered with a wireless NVR according to an exemplary embodiment of the present disclosure.

FIG. 3 is a block diagram illustrating a configuration of a wireless NVR capable of automatically registering a wireless camera according to an exemplary embodiment of the present disclosure.

FIG. 4 is a flowchart illustrating a method for registering a wireless camera with a wireless NVR according to an exemplary embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

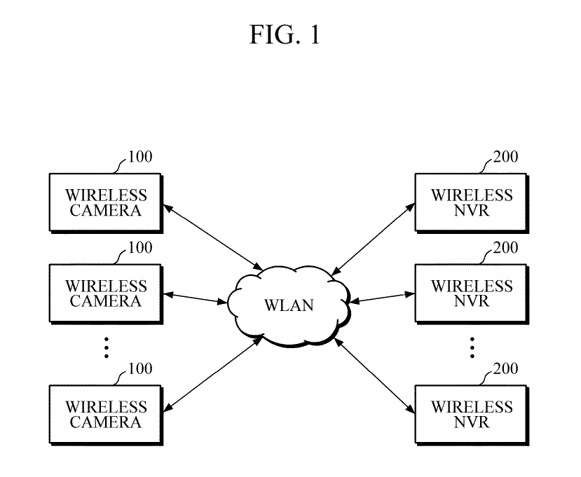

FIG. 1 is a diagram illustrating a wireless Network Video Recorder (NVR) network system. Referring to FIG. 1, at least one wireless camera 100 is connected to at least one wireless NVR 200 over a Wireless Local Area Network (WLAN).

The present disclosure aims to enable a wireless camera acting as a station automatically connects to a wireless NVR acting as an Access Point (AP) without additional manipulation of a user, once a user turns on the wireless NVR and the wireless camera. Accordingly, convenience of the user may improve.

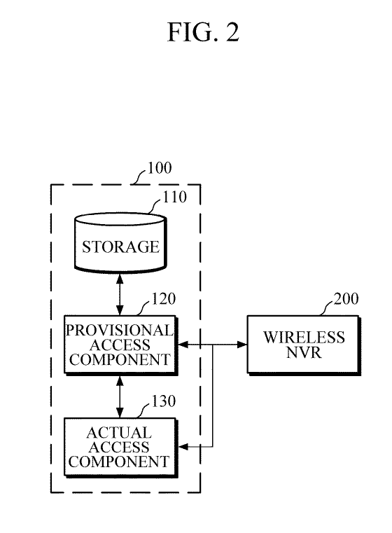

FIG. 2 is a block diagram illustrating a configuration of a wireless camera capable of being automatically registered with a wireless NVR according to an exemplary embodiment of the present disclosure. Referring to FIG. 2, a wireless camera 100 capable of being automatically registered with a wireless NVR includes a storage 110, a provisional access component 120, an actual access component 130.

The storage 110 stores a list of Service Set Identifiers (SSIDs) of wireless NVRs respectively acting as Access Points (APs) and an initial access password for each SSID.

The list of SSIDs of wireless NVRs and initial access passwords for the respective SSIDs may have been stored in the storage when a camera was manufactured.

For example, an SSID for each wireless NVR may be a combination of characters and numbers, such as ITX-NVR-00, ITX-NVR-01, . . . , and ITX-NVR-99. In addition, an initial access password for ITX-NVR-00 may be ITX-CA-00, an initial access password for ITX-NVR-01 may be ITX-CA-01, . . . , and an initial access password for ITX-NVR-99 may be ITX-CA-99.

Once the wireless camera is turned on, the provisional access component 120 makes an attempt for a provisional access to the wireless NVRs in sequence using the list of SSIDs of the wireless NVRs and the initial access passwords for the respective SSIDs.

For example, suppose that a user has a wireless camera 100 and a wireless NVR 200 with an SSID of ITX-NVR-33 and an initial access password for ITX-CA-33. In this case, if the user turns on the wireless camera 100 and the wireless NVR 200, the wireless camera 100 makes an attempt for access to the entire wireless NVRs by reference to the list of SSIDs of the wireless NVRs and initial access passwords for the respective SSIDs in order starting from a wireless NVR with ITX-NVR-00 and ITX-CA-00, and establishes provisional access to the wireless NVR with ITX-NVR-33 and ITX-CA-33.

The actual access component 130 requests authentication in accordance with a predefined protocol from the wireless NVR 200 with which the provisional access has been established. The predefined protocol may be changing an initial access password into a new access password, or may be defined in other various ways.

Accordingly, in an access procedure before establishing connection between the wireless NVR 200 and the wireless camera 100, the wireless camera 100 automatically access the wireless NVR 200 using a plug-and-play technique.

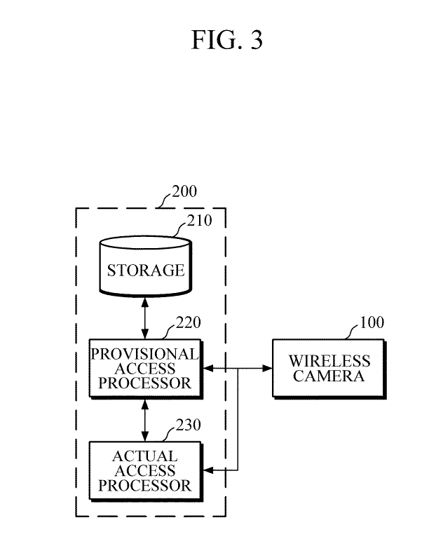

FIG. 3 is a block diagram illustrating a configuration of a wireless NVR capable of automatically registering a wireless camera according to an exemplary embodiment of the present disclosure. In the embodiment shown in FIG. 3, a wireless NVR 200 capable of automatically registering a wireless camera includes a storage 210, a provisional access processor 220, and an actual access processor 230.

The storage 210 stores a SSID of the wireless NVR 200 and an initial access password for the SSID. The SSID and initial access password with respect to the wireless NVR 200 were stored in the storage when the wireless NVR 200 was manufactured.

For example, an SSID of a wireless NVR may be a combination of characters and numbers, such as ITX-NVR-33. An initial access password for ITX-NVR-33 may be also a combination of characters and numbers.

In the case where an SSID and an initial access password included in a provisional access request from a particular wireless camera 100 acting as a station match the SSID and the initial access password stored in the storage 210 of the wireless NVR, respectively, the provisional access processor 220 allows provisional access to the particular wireless camera 100.

In accordance with a predefined protocol, the actual access processor 230 verifies authentication of the particular wireless camera 100 with which the provisional access has been established. Then, if the authentication is confirmed, the actual access processor 230 allows actual access to the particular wireless camera 100.

At this point, the actual access processor 230 may output a user interface for receiving a user's confirmation of allowance of provisional access to the particular wireless camera 100. When confirmation from the user is received, the actual access processor 230 may allow the provisional access to the particular wireless camera 100, and wait for authentication of the particular wireless camera in accordance with a predefined protocol.

For example, the actual access processor 230 may output a sentence “Ready to register with a camera. Would you allow it?” on a user interface. Then, if a user clicks a button, the actual access processor 230 allows provisional access.

In the case of failure of authentication of the particular wireless camera 100 with which the provisional access has been established, the actual access processor 230 may block access to the particular wireless camera 100.

For example, the predefined protocol may be changing an initial access password into a new access password. In this case, if a request for changing an initial access password into a new access password is received from the particular wireless camera 100, the actual access processor 230 allows actual access to the particular wireless camera 100. Alternatively, if a request for changing an initial access password into a new access password is not received from the particular wireless camera 100, the actual access processor 230 may determines the provisional access to the particular wireless camera 100 to be malicious, and block actual access to the particular wireless camera 100.

Accordingly, in an access procedure before establishing connection between the wireless NVR 200 and the wireless camera 100, the wireless NVR 200 automatically processes access to the wireless camera 100.

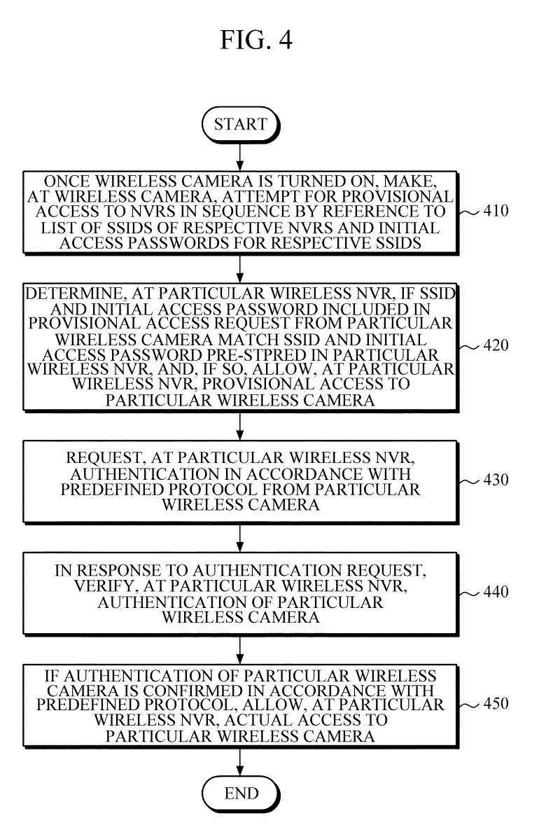

The access procedure between the wireless camera 100 and the wireless NVR 200 is described with reference to FIG. 4. FIG. 4 is a flowchart illustrating a method for automatically registering a wireless camera with an NVR according to an exemplary embodiment of the present disclosure.

In 410, once the wireless camera is turned on, a wireless camera makes an attempt for provisional access to wireless NVRs by reference to a list of SSIDs for the respective NVRs and initial access passwords for the respective SSIDs.

Then, in 420, a particular wireless NVR determines if an SSID and an initial access password included in a provisional access request transmitted in operation 410 from a particular wireless camera match an SSID and an initial access password pre-stored in the particular wireless NVR. If so, the particular wireless NVR allows provisional access to the particular wireless camera.

Then, in 430, the particular wireless camera requests authentication in accordance with a predefined protocol from the particular wireless NVR with which the provisional access has been established.

Then, in 440, in response to the authentication request, the particular wireless NVR verifies authentication of the particular wireless camera in accordance with a predefined protocol. The predefined protocol may be changing an initial access password into a new access password, and may be defined in other various ways.

Then, in 450, in the case where the authentication of the particular wireless NVR is confirmed, the particular wireless NVR allows actual access to the particular wireless camera. Alternatively, in the case where the authentication of the particular wireless NVR is failed, the particular wireless NVR determines the provisional access to be malicious and blocks actual access to the particular wireless camera.

Accordingly, in the present disclosure, access of a wireless camera to wireless NVR is made automatically using a plug-and-play technique in an access procedure before connection is established between the wireless NVR and the wireless camera. By doing so, the present disclosure may improve user convenience and achieve the aforementioned objective.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wireless camera capable of being automatically registered with a wireless Network Video Recorder (NVR), comprising:
a storage configured to store a list of Service Set Identifiers (SSIDs) of wireless NVRs acting as Access Points (APs) and initial access password for the respective SSIDs;
a provisional access component configured to, once the wireless camera is turned on, make an attempt for provisional access to the wireless NVRs in sequence by reference to the list of SSIDs for the wireless NVRs and the initial access passwords for the respective SSIDs; and
an actual access component configured to request authentication in accordance with a predefined protocol from a particular wireless NVR with which the provisional access has been established, and, in response to confirmation of the authentication from the particular wireless NVR, establish actual access to the particular wireless NVR.

2. The wireless camera of claim 1, wherein the predefined protocol comprises changing an initial access password into a new access password.

3. A wireless Network Video Recorder (NVR) capable of automatically registering a wireless camera, comprising:
a storage configured to store a Service Set Identifier (SSID) of the wireless NVR and an initial access password for the SSID;
a provisional access processor configured to determine if an SSID and an initial access password included in a provisional access request from a particular wireless camera acting as a station match the SSID and the initial access password stored in the storage of the wireless NVR, and, if so, allow provisional access to the particular wireless camera; and
an actual access processor configured to, in response to an authentication request from the particular wireless camera with which the provisional access has been established, verify authentication of the particular wireless camera in accordance with a predefined protocol, and, in response to confirmation of the authentication, allow actual access to the particular wireless camera.

4. The wireless NVR of claim 3, wherein the predefined protocol comprises changing an initial access password into a new access password.

5. The wireless NVR of claim 3, wherein the actual access processor is further configured to output a user interface for receiving confirmation of allowance of the provisional access, in response to the confirmation from a user, allow the provisional access to the particular wireless camera, and wait for the authentication of the particular wireless camera according to the predefined protocol.

6. The wireless NVR of claim 3, wherein the actual access processor is further configured to, in response to failure of the authentication of the particular wireless camera, block access to the particular wireless camera.

7. A method for automatically registering a wireless camera to a wireless Network Video Recorder, comprising:
once the wireless camera is turned on, making, at the wireless camera, an attempt for provisional access to wireless Network Video Recorders (NVRs) by reference to a pre-stored list of Service Set Identifiers (SSIDs) of the respective wireless NVRs and initial access passwords for the respective SSIDs;
allowing, at a particular wireless NVR, provisional access to a particular wireless camera in a case where an SSID and an initial access password included in a provisional access request from the particular wireless camera match an SSID and an initial access password pre-stored in the particular wireless NVR;
requesting, at the particular wireless camera with which the provisional access has been established, authentication in accordance with a predefined protocol from the particular wireless NVR;
verifying, at the particular wireless NVR, authentication of the particular wireless camera in accordance with the predefined protocol; and
in response to confirmation of the authentication of the particular wireless camera, allowing, at the particular wireless NVR, actual access to the particular wireless camera.
